(19) United States
(12) Patent Application Publication
(10) Pub. No.: US 2003/0204835 A1
(43) Pub. Date: Oct. 30, 2003

(54) Versioning method for business process models

(75) Inventors: Navin Budhiraja, Fremont, CA (US); Elisa J. Rubin, San Jose, CA (US); Haiying Wang, Fremont, CA (US)

Correspondence Address: ATTEN: NIXON PEABODY LLP, 8180 GREENSBORO DRIVE, McLEAN, VA, 22102, US

(73) Assignee: Versioning Method for Business Process Models

(21) Appl. No.: 09/823,953

(22) Filed: Mar. 30, 2001

(51) Int. Cl. G06F 9/44; G06F 12/00; G06F 15/00

(52) U.S. Cl. 717/120; 707/203; 715/511

(57) ABSTRACT

A method for versioning business process models within BPM systems is provided. For this method, each version of a business process model is allowed to have an associated label. The label is defined by a user of a process modeler within a BPM system. The user can also choose the active version of each business process model. The business process server (execution engine) of the BPM system creates business process models using the active versions of the business process models. Changes in an active version (i.e., by replacement with a new active version) do not effect existing business process models. These existing business process models continue using the business process models with which they are created. In this way, the versioning method allows business process models to be changed within active BPM systems, without the need for system shutdown.

### TECHNICAL FIELD OF THE INVENTION

The present invention relates generally to computer software and to methods for business process management. More particularly, the present invention includes a method that allows a business process management system to support multiple versions of a single business process model.

### BACKGROUND OF THE INVENTION

A business process management system (BPM system) is a computer system that automates business processes. Business processes are steps that a business undertakes to accomplish some objective, such as hiring an employee or procuring components required for production. BPM systems automate business processes by managing business process objects. A business process object is an entity that exists within the context of a BPM system and represents a business process instance.

As an example, consider the case of a retail business. For this type of environment, a BPM system might be constructed to track customer orders. A business process object would represent each order. The BPM system used by the retail business would manage customer orders by manipulating the corresponding business process objects.

BPM systems are typically designed in a way that makes their behavior easy to customize. This allows the same underlying system to be deployed in a range of different environments and applications, such as manufacturing, retail sales, and business to business applications.

To provide this type of flexibility, some BPM systems have adopted a model-driven approach. BPM systems of this type allow model-designers to describe business processes in terms of business process models. A business process model is a formal definition of a business process in a high-level graphical modeling language such as UML (Uniform Modeling Language).

Business process models define the runtime behavior of business process objects using state diagrams. FIG. 1 shows an example of a state diagram of this type. This particular state diagram begins with an initial state where an order is received. The initial state is followed by two states: a first for existing customers and a second for new customers. These two states are followed by a final state where the order is processed.

The connections between states are known as transitions. Model designers define transitions as part of the process of defining state diagrams. In this way, users get to choose the permissible paths through state diagrams.

Objects traverse transitions and move between states in response to events. Events are notification within the BPM system that something has happened in the real world. Customers placing orders and customers canceling orders are two examples of events.

The ability to define objects, state diagrams (including states and transitions) and events provides users with a highly flexible and intuitive mechanism for customizing the behavior of model-driven BPM systems. Model designers get to define the entities processed by the BPM systems (in term of objects), the runtime behavior of those entities (state diagrams) and the interaction between the real world and the BPM system (events). This mechanism is even more powerful because it lends itself to creation and manipulation within graphical or visual design environments. This allows users to define state diagrams by drawing, for example. In this way, model-driven BPM systems greatly reduce the need for highly skilled programmers.

One shortcoming of current BPM systems arises when modifications are made to a business process model within an operational BPM system. Modifications of this type generally require replacing the current version of a business process model with a modified version. Unfortunately, in operational BPM systems, it may be undesirable or impossible to halt the system to update a business process model. Even in cases where this is possible, shutdown may still be difficult if the system is populated with objects created using the old version of a business process model. This is this case, for example, where a system contains pending orders at the time of shutdown. As a result, shutdown often requires that the system be maintained in a partially operational configuration (e.g., up but not accepting new orders) until a quiescent state is reached.

This type of shortcoming is particularly apparent when BPM systems are used as part of larger Enterprise Application Integration (EAI) systems. EAI systems are used to integrate multiple heterogeneous software applications within an enterprise. In many cases, EAI systems are used in a hub and spoke configuration where a centrally located EAI system facilitates cooperation between a group of dispersed applications. In the business to business arena (B2B), the dispersed applications may be operated by a group of different companies or organizations (e.g., manufacturing and supply organizations). Cases like this present another scenario where it is difficult to change business process models. This follows because changes of this type often require changes to the applications. As a result, it may take an extended period may be required to propagate changes to all applications and all organizations. Halting the BPM system down to facilitate the updating process is not always practical or possible.

As a result, there is a need for methods that simplify the modification of business process models in operational BPM systems. This need is particularly important where BPM systems are used in environments where system shutdown is difficult or otherwise undesirable.

### SUMMARY OF THE INVENTION

An embodiment of the present invention provides a method for versioning business process models within BPM systems. For this method, each version of a business process model is allowed to have an associated label. The label is defined by a model designer using a process modeler within a BPM system. The model designer can also choose the active version of each business process model. During runtime, the Business Process Manager of the BPM system creates Business Process Object using the active versions of the business process models. Changes in an active version (i.e., by replacement with a new active version) do not effect existing business process objects. These existing business process objects continue using the business process models with which they are created. In this way, the versioning method allows business process models to be changed within active BPM systems, without the need for system shutdown.

Stated differently, the present invention includes a method for supporting multiple versions of a business process model, the method comprising the steps of: 1) designating a selected version of a business process model as active; 2) creating a new Business Process Object using the active version of the business process model; and 2) continuing any existing business process objects using the respective versions of the business process model with which they were created.

Other aspects and advantages of the present invention will become apparent from the following descriptions and accompanying drawings.

### BRIEF DESCRIPTION OF THE DRAWINGS

For a more complete understanding of the present invention and for further features and advantages, reference is now made to the following description taken in conjunction with the accompanying drawings, in which:

FIG. 1 is a state diagram as used in a business process model.

FIG. 2 is a block diagram of an Internet-like network shown as a representative environment for deployment of the present invention.

FIG. 2 is a block diagram of a computer system as used within the network of FIG. 2.

FIG. 4 is a block diagram showing the components of a BPM system compatible with an embodiment of the present invention.

### DETAILED DESCRIPTION OF THE PREFERRED EMBODIMENTS

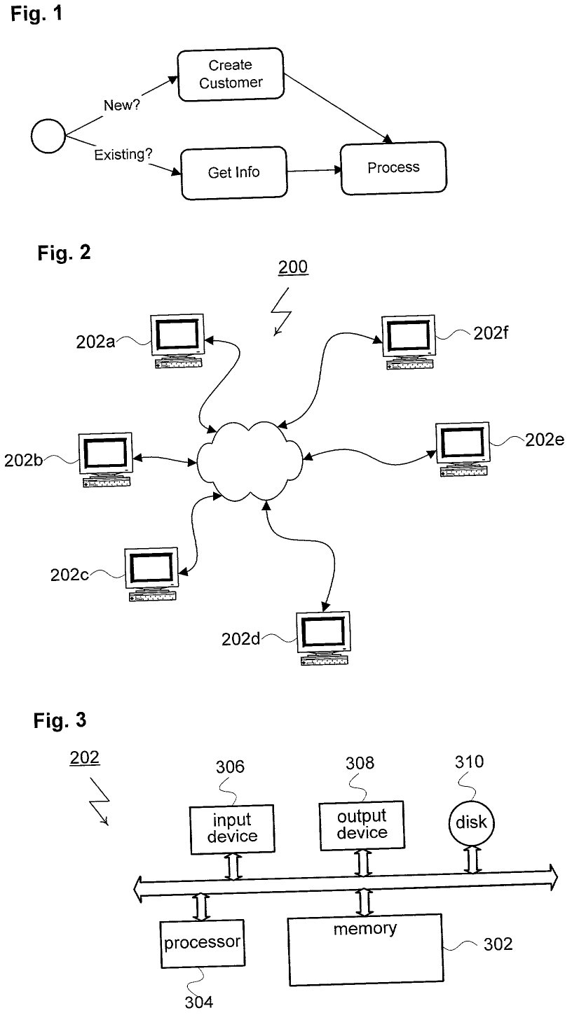

The preferred embodiments of the present invention and their advantages are best understood by referring to FIGS. 1 through 4 of the drawings. Like numerals are used for like and corresponding parts of the various drawings.

Definitions

Business Process: a series of steps that a business undertakes to accomplish some objective, such as hiring an employee; acquiring a new customer; fulfilling a customer order; provisioning a new service; enrolling a new partner. For the purposes of this document this definition includes lower-level processes that support businesses, such as processes to synchronize disparate databases, etc. The steps in a business process may be automated, manual or a combination of both.

Business Process Model: the formal definition of a business process in a high-level graphical modeling language.

Business Process Instance: An instance of a business process. For example, the fulfillment of Joe Smith's order is considered an “instance” of the more general order fulfillment business process. Note that each customer order being fulfilled would be an instance of the Order Fulfillment Business Process. Hence, a business process typically will have many instances.

Business Process Object: the computerized representation of a business process instance.

Environment

In FIG. 2, a conventional computer network 200 is shown as a representative environment for an embodiment of the present invention. Computer network 200 is intended to be representative of the complete spectrum of computer network types including Internet and internet-like networks. Computer network 200 includes a number of computer systems, of which computer systems 202a through 202f are representative. Computer systems 202 are intended to be representative of the wide range of large and small computer systems that are used in computer networks of all types.

FIG. 3 shows a representative implementation for computer systems 202. Structurally, each computer system 202 conventionally includes a processor, or processors 302, and a memory 304. Processor 302 can be selected from a wide range of commercially available or custom types. An input device 306 and an output device 308 are connected to processor 302 and memory 304. Input device 306 and output device 308 represent all types of I/O devices such as disk drives, keyboards, modems, network adapters, printers and displays. Each computer system 202 may also include a disk drive 310 of any suitable disk drive type (equivalently, disk drive 310 may be any non-volatile mass storage system such as “flash” memory).

Overview of Compatible BPM System

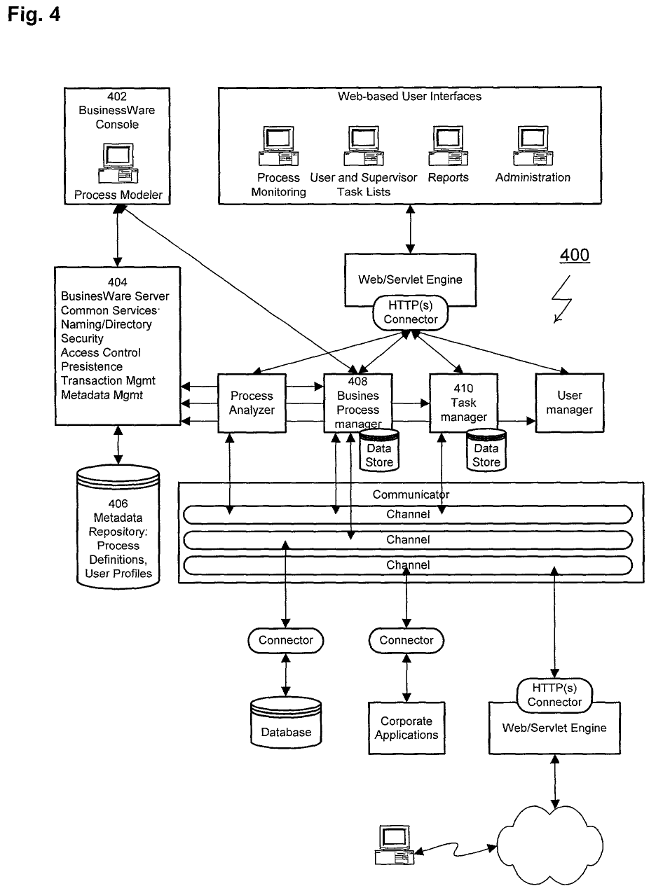

An embodiment of the present invention provides a method for versioning business process models. This method is preferably (but not necessarily) used in combination with a model-driven BPM system. To better describe this method, FIG. 4 shows a model-driven BPM system 400 deployed as part of an EAI system. BPM system 400 is intended to be representative of BPM systems that are suitable for use with the versioning method.

As shown in FIG. 4, BPM system 400 includes a process modeler 402. Process modeler 402 is an interactive interface, preferably graphical, that allows users to create and modify business process models. The business process models are preferably UML (Uniform Modeling Language) based, with process modeler 402 being a visual environment for manipulating UML constructs.

BusinessWare server 404 maintains the business process models created and modified by process modeler 402. Process modeler 402 retrieves business process models from BusinessWare server 404 and stores business process models to BusinessWare server 404 on an as-needed basis.

BusinessWare server 404 preferably maintains a copy of each business process model in metadata repository 406. Metadata repository 406 is a disk or other persistent storage device that ensures that business process models are not lost during system shutdowns and outages.

BusinessWare server 404 allows process modeler 402 to lookup business process models by name. In particular, since the BusinessWare server 404 can store multiple business process models at any time, each business process model has a unique name associated with it. So whenever process modeler 402 needs to access a particular business process model, it provides a name that can be used to find the business process.

Business process manager 408 is the runtime environment for business process objects within BPM system 400. Business process manager 408 creates business process objects using the business process models maintained by businessware server 404. Each business process object is an instance of the corresponding business process model. For this particular implementation, task manager 410 helps by adding support for the human-based or manual portions of these business process objects.

Business process manager 408 has the ability to persistently save (checkpoint) and recover the state of the business process objects it creates. For the particular implementation shown, business process manager 408 uses a database (data store) for this purpose. Other implementations may use different persistent storage methods.

In general, it should be appreciated that the particular selection, interconnection and arrangement of components shown in FIG. 4 is intended to be representative of compatible BPM systems. Additional details of this particular architecture are provided in a copending, concurrently-filed US Application entitled “Method for Incorporating Human-Based Activities in Business Process Models.” That disclosure is incorporated in this document by reference.

Method for Versioning Business Process Models

BusinessWare server 404 is configured so that multiple versions of each business process model may be stored and retrieved. To support versions, BusinessWare server 404 allows each business process model to have one or more associated labels. Each label is a symbolic name for a particular version of the associated business process model. BusinessWare server 404 provides an interface that allows business process models to be stored and retrieved by specifying a combination of name and label.

The checkpointing ability of Business process manager 408 is extended so that name and label information is included with saved state information. This means that each time that business process manager 408 saves the state of a business process object, it also saves the name and label associated with the business process model used to create that business process object.

Process modeler 402 is configured to allow users to specify the labels that are associated with the different versions of business process models. Thus, a user could specify “released” and “experimental” versions for a particular business process model. By default, process modeler 402 maintains two labels for each business process model. The default labels are “initial” and “latest” for the first and most current versions of each business process model, respectively.

Process modeler 402 also allows the user to specify which version of a business process model is active. BusinessWare server 404 uses the active version when creating new business process objects. In this way, the user can control, for example, the version of a business process model that is created to represent a new order. The designation of the active version does not impact already existing business process objects. These business process objects continue to use the version of the business process model with which they were created. This means, for example, that already existing orders would not be impacted by a new version of its business process model.

This combination provides a mechanism that allows business process models to be changed in active BPM systems. There is no need to halt an active BPM system to accomplish a model change (systems of the type frequently need to be accessible on a continuous basis). Existing business process objects, such as orders, continue to use the models active at the time of their creation. As a result, existing business process objects are protected from the possibility that a new model will be incompatible. In particular, it should be appreciated that the present invention supports the simultaneous existence of multiple versions of each business process model. This facilitates changes in online order taking systems as well as the previously described B2B environment where a BPM system interconnects a range of applications controlled by different entities.

Nested Business Process Models

In some cases, it is useful to create business process models using a hierarchical, nested structure. This is true, for example, when different portions of a business process model include the same sequence of states. The common sequence can be isolated and turned into a sub-process model. The original process model is then changed to include calls (in the appropriate locations) to the sub-process model. Nesting simplifies the construction of business process models. It also encourages software reuse by allowing sub-models to be reused as components for new business process models.

In general, there are two basic methods for binding process model calls to sub-process model. The first of these methods is known as static binding. In static binding, the sub-process model is bound or resolved at the time that the process model is created. For dynamic binding the sub-process model is bound during runtime. This typically happens as part of the first call to the sub-process model.

Process modeler 402 and BusinessWare server 404 are configured so that sub-process models may be labeled in the same way as business process models. Thus, there may be multiple versions of a sub-process model. Each definition may have an associated label including an “initial” and a “current” version. The checkpointing ability of Business process manager 408 is configured to include the version information for sub-process models during state saving operations. This allows business process objects to be restarted using the correct versions of their nested sub-process models.

Implicit and Other Labeling Systems

The preceding sections describe a system in which the user associates labels with particular versions of business process models. In general, it may be appreciated that this is just one possible labeling scheme. Other schemes, including systems where versions are automatically labeled, are also practical.

### CONCLUSION

Although particular embodiments of the present invention have been shown and described, it will be apparent to those skilled in the art that changes and modifications may be made without departing from the present invention in its broader aspects, and therefore, the appended claims are to encompass within their scope all such changes and modifications that fall within the true scope of the present invention.

What is claimed is:

1. A method for supporting multiple versions of a business process model, the method comprising the steps of:
designating a selected version of a business process model as active;
creating a new business process object using the active version of the business process model; and
continuing any existing business process objects using the respective versions of the business process model with which they were created.

2. A method as recited in claim 1 further comprising the step of checkpointing the state information of a business process object, where the state information includes the version of the business process model with which the business process object was created.

3. A method as recited in claim 2 further comprising the steps of:
restoring a business process object using the checkpointed state information; and
continuing the business process object using the version included in the checkpointed information.

4. A method as recited in claim 1 wherein each version of each business process model has an associated label.

5. A method as recited in claim 4 wherein each label is defined by a model designer using a process modeler.

6. A method as recited in claim 1 further comprising the step of persistently storing each version of the business process model.

7. A method as recited in claim 1 wherein the business process model includes at least one nested sub-process model.

8. A data storage medium having machine-readable code stored thereon, the machine-readable code comprising instructions executable by an array of logic elements, the instructions defining a method comprising the steps of:
designating a selected version of a business process model as active;
creating a new business process object using the active version of the business process model; and
continuing any existing business process objects using the respective versions of the business process model with which they were created.

9. A data storage medium as recited in claim 8 with the method further comprising the step of checkpointing the state information of a business process object, where the state information includes the version of the business process model with which the business process object was created.

10. A data storage medium as recited in claim 9 with the method further comprising the steps of:
restoring a business process object using the checkpointed state information; and
continuing the business process object using the version included in the checkpointed information.

11. A data storage medium as recited in claim 7 wherein each version of each business process model has an associated label.

12. A data storage medium as recited in claim 11 wherein each label is defined by a model designer using a process modeler.

13. A data storage medium as recited in claim 7 with the method further comprising the step of persistently storing each version of the process model.

14. A data storage medium as recited in claim 7 wherein the business process model includes at least one nested sub-process model.
